(19) United States
(12) Patent Application Publication
(10) Pub. No.: US 2004/0099787 A1
(43) Pub. Date: May 27, 2004

(54) System and method for determining optical aberrations in scanning imaging systems by phase diversity

(75) Inventors: Jean J. Dolne, Thousand Oaks, CA (US); David R. Gerwe, Woodland Hills, CA (US); Paul S. Idell, Thousand Oaks, CA (US); Victor Wang, Redondo Beach, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company

(21) Appl. No.: 10/304,042

(22) Filed: Nov. 25, 2002

(51) Int. Cl. G02B 7/04; G02B 27/40

(52) U.S. Cl. 250/201.2

(57) ABSTRACT

An imaging system and method are provided to detect optical aberrations, such as for a scanning-array imaging system. The imaging system includes an optical system for capturing an image of an object and for focusing the image on a surface generally perpendicular to an optical axis. The imaging system also includes first and second focal plane arrays. The second focal plane array is proximate the first focal plane array, but is optically displaced from the first focal plane array by a predetermined optical path distance along the optical axis and in the in-track direction. The second focal plane array receives a defocused image having a predefined difference in focus relative to the image received by the first focal plane array, and displaced in time from the image received by the first focal plane. By analyzing the images obtained by the focal plane arrays, the imaging system detects optical aberrations.

### BACKGROUND OF THE INVENTION

The present invention relates generally to imaging systems and methods for detecting optical aberrations and, more particularly, to imaging systems and methods for detecting optical aberrations via a phase diversity technique utilizing differently focused images of an object.

A wide variety of optical imaging systems are commonly utilized in a myriad of applications. One type of optical imaging system is a line-scanned imaging system that may be employed in a variety of applications including photocopiers, scanners, high-resolution photo reconnaissance cameras and the like. A line-scanned imaging system captures a series of linear images of different portions of an object. In this regard, a line-scanned imaging system may be scanned across an object in order to obtain the series of images and/or the object may be in motion relative to the line-scanned imaging system such that the sequential images obtained by the line-scanned imaging system depict different portions of the object.

Imaging systems generally introduce at least some aberrations into the image of the object that is captured. These optical aberrations may be due to imperfections in the optical elements themselves, inaccuracies in the positioning and alignment of the optical elements, or aberrations introduced by the atmospheric medium between the optics and the source scene. As will be apparent, the optical aberrations introduced by imaging systems are undesirable since the aberrations detract from the quality of the resulting image. Regardless of the type of imaging system, it would therefore be desirable to reduce, if not eliminate, the optical aberrations otherwise introduced by the imaging system or the effects thereof.

In order to provide correction or compensation for the aberrations, the optical aberrations must first be detected. Several techniques have been developed to detect the optical aberrations introduced by an imaging system. According to one interferometric-based technique, a reference beam is transmitted through both the imaging system and a reference system having predefined optical characteristics. By comparing the image of the reference beam created by the imaging system and the reference system, optical aberrations introduced by the imaging system may be detected. Similarly, a reference point source may be utilized to illuminate an imaging system. The image of the point source generated by the imaging system may be detected by a wavefront sensor and utilized to detect optical aberrations. Unfortunately, these techniques for detecting the optical aberrations introduced by imaging systems not only require a reference, such as a reference beam or a reference point source, but also require additional optical elements. These additional optical elements may be relatively expensive and disadvantageously add to the complexity and weight of the imaging system.

Phase diversity techniques have also been developed to detect the optical aberrations introduced by an imaging system. By utilizing phase diversity techniques, the optical aberrations introduced by an imaging system are estimated from two or more images that are simultaneously collected by the imaging system. In this regard, the imaging system generally includes a beam splitter for dividing the image into at least two beams that are directed to different focal plane arrays. One focal plane array is positioned such that the image is in focus, while one or more other focal plane arrays are positioned such that the image is defocused. By appropriately analyzing the in-focus and defocused images, the optical aberrations of the imaging system can be determined and appropriate corrections may be made. See, for example, R. A. Gonsalves, J. Opt. Soc. Am. 66, p. 961 (1976) and R. A. Gonsalves “Phase Retrieval and Diversity in Adaptive Optics”, Opt. Eng., 21, pp. 829-32 (1982) for a more detailed description of conventional phase diversity techniques.

While phase diversity techniques utilizing a beam splitter and two different focal plane arrays permit the optical aberrations introduced by an imaging system to be detected, this technique adds several additional components to the imaging system including a beam splitter and an additional focal plane array. As such, the cost, complexity and weight of the imaging system are disadvantageously increased. Additionally, the beam splitter may also introduce additional aberrations and generally reduces the signal strength of the image.

As a result, it would be desirable to develop an improved imaging system for reliably detecting optical aberrations introduced by the imaging system so that the quality of the image created by the imaging system may be improved by modification of the imaging system to correct or compensate for the detected aberrations by physical adjustment to the system or by image post-processing techniques. Moreover, it would be desirable to develop an imaging system that could detect optical aberrations introduced by the imaging system in a manner that does not substantially increase the cost, complexity and/or weight of the imaging system.

### BRIEF SUMMARY OF THE INVENTION

An improved imaging system and method are therefore provided according to the present invention in order to detect optical aberrations introduced by the imaging system, generally without substantially increasing the cost, complexity and/or weight of the imaging system. The imaging system includes an optical system for capturing an image of an object and for focusing the image on a surface generally perpendicular to an optical axis. The imaging system also includes a focal plane array assembly. According to the present invention, the focal plane array assembly includes a first and one or more secondary focal plane arrays, each including a plurality of pixels. The first focal plane array is typically, but not necessarily, positioned to receive an in-focus image of the object from the optical system. Each secondary focal plane array is positioned proximate the first focal plane array, but is optically displaced from the first focal plane array by a predetermined optical path distance along the optical axis. As such, each second focal plane array receives a defocused image of the object from the optical system with the defocused image having a predefined difference in focus relative to the image received by the first focal plane array. By appropriately analyzing the images obtained by the first, second and any additional focal plane arrays, the optical aberrations introduced by the imaging system may be determined.

In one advantageous embodiment in which the optical system is a line-scanned optical system, in addition to being optically displaced along the optical axis, the focal planes are displaced from one another along the in-track direction. In this way, the focal plane arrays access the image scene sequentially to each other in time as the optical system scans the image of the scene. This displacement of the focal planes along the in-track direction is advantageous relative to conventional phase diversity techniques which utilize a beam-splitting device to direct the image onto the multiple focal plane arrays since splitting reduces the optical power and image quality delivered to either focal-plane array and adds complexity to the optical system.

The optical displacement between the first and second focal plane arrays may be established in various manners. For example, each focal plane array generally includes a support, such as a circuit board, upon which a plurality of pixels is disposed, such as along an edge thereof. In embodiments in which each focal plane array includes a respective support, the supports may be staggered or otherwise positioned to introduce the predetermined optical path difference. In an alternative embodiment, the supports of the first and second focal plane arrays may be a common circuit board which carries the pixels of both the first and second focal plane arrays. Regardless of the commonality of the support upon which the pixels are disposed, the pixels of the second focal plane array may differ in height from the pixels of the first focal plane array to establish the predetermined optical path distance. In another advantageous embodiment, the predetermined optical path difference is provided optically, instead of by physical separation. In this embodiment an optical element, such as a glass prism, may be placed in front of one or more focal plane arrays to change the relative optical path length to the focal plane array, thus inducing a relative difference in focus between the arrays. In each embodiment, however, the end effect is to induce a well characterized relative difference in focus between the arrays without the need for splitting or bending the optical beam.

The secondary focal plane arrays need not be the same size as the first focal plane array. According to one advantageous embodiment, for example, secondary focal plane arrays may include a plurality of segments spaced apart from one another, each of which includes a plurality of pixels. According to this embodiment, the segments of the secondary focal plane arrays are positioned proximate to different respective portions of the first focal plane array. By interpolation or other approximation techniques, the portions of the defocused image captured by the segments of the second focal plane array may be utilized to estimate the optical aberrations over the entire image field. By constructing the second focal plane array from a plurality of segments, however, the cost,, complexity of electrical readout, and the data capacity requirements associated with the second focal plane array are correspondingly reduced.

In one advantageous embodiment, images of an object are focused on a surface generally perpendicular to the optical axis and are sequentially scanned in an in-track direction across at least first and second focal plane arrays which are offset in both the in-track direction and along the optical axis. Images of the object are then received by the first and second focal plane arrays with the images received by at least one of the focal plane arrays being defocused. In this regard, the image received by the second focal plane array experiences a predefined optical path difference relative to the image received by the first focal plane array, thereby establishing a predefined difference in focus between the images received by the first and second focal plane arrays.

According to the present invention, an improved imaging system and method are therefore provided to detect optical aberrations introduced by the imaging system such that appropriate corrections and/or compensation may be provided to reduce, if not eliminate, the aberrations, thereby improving the quality of the resulting images captured by the imaging system. By capturing differently focused images with first and second focal plane arrays that are positioned proximate one another and optically displaced by the predetermined optical path distance along the optical axis, the images required for phase diversity analysis purposes can be captured without significantly increasing the cost, complexity and/or weight of the imaging system. Moreover, the imaging system and method can capture and analyze the images without requiring a reference beam and/or a reference point source as required by at least some conventional imaging systems that provide the capability of detecting aberrations. Similarly, the imaging system and method does not include a beam splitter or other optical elements for splitting the image between the focal plane arrays and, as such, does not reduce the signal strength of the image as required by at least some conventional phase diversity imaging systems.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic representation of an imaging system according to one embodiment of the present invention;

FIG. 2 is a plan view of a focal plane array assembly according to one embodiment of the present invention;

FIG. 3 is a schematic side view of respective pixels of the first and second focal plane arrays according to one embodiment of the present invention depicting the difference in height of the pixels; and

FIG. 4 is a plan view of a focal plane array assembly according to another embodiment of the present invention in which the second focal plane array includes a plurality of segments spaced apart from one another.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

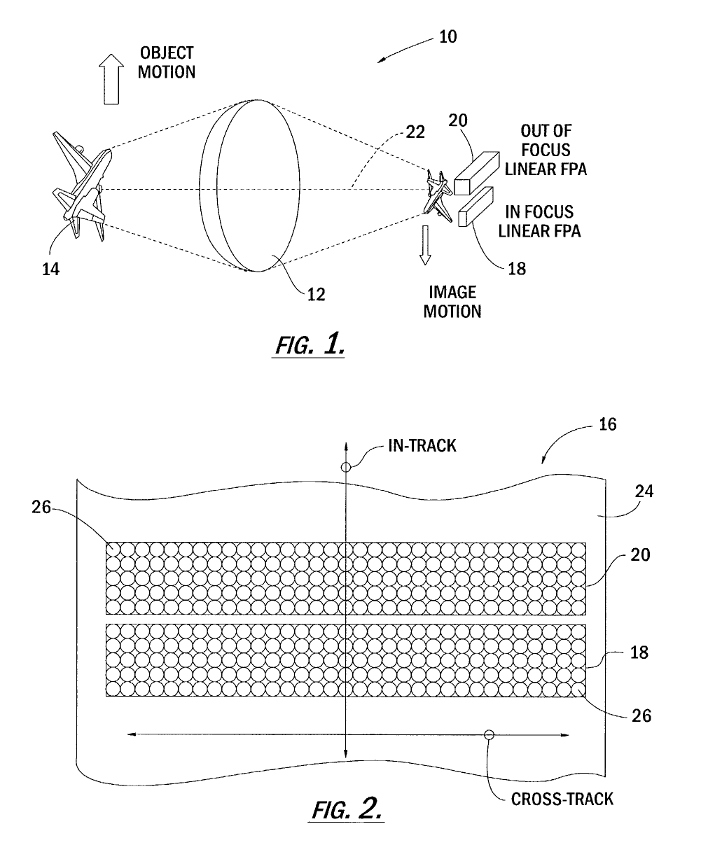

Referring now to FIG. 1, an imaging system 10 according to one embodiment of the present invention is schematically depicted. As will be apparent to those skilled in the art, the imaging system can be utilized in a wide variety of applications. For example, the imaging system may be utilized by other reconnaissance cameras, photocopiers and scanners to name a few applications. The imaging system includes an optical system 12 for capturing an image of an object 14 and for focusing the image. The optical system is summarically illustrated as an optical train in FIG. 1, but can include any conventional optical system known to those skilled in the art that captures an image of an object and focuses the image upon a focal plane array.

In one advantageous embodiment, the optical system 12 is a line-scanned optical system. As known to those skilled in the art, a line-scanned optical system repeatedly captures linear images of the object 14. As a result of the scanning, the series of linear images of the object are generally spaced apart from one another in an in-track direction. As also known to those skilled in the art, a line-scanned optical system can be scanned relative to the object such that the optical system is sequentially pointed at different portions of the object, thereby serially capturing images of the different portions of the object. In addition to or instead of scanning of the optical system, the object may move relative to the optical system to effect the scanning of the object.

In addition to the optical system 12, the imaging system 10 of the present invention includes a focal plane array (FPA) assembly 16. The focal plane array assembly includes at least first and second focal plane arrays 18, 20. While the FPA assembly will be described hereinafter as having a pair of focal plane arrays, the FPA assembly may include additional focal plane assemblies, each optically displaced from the others by a predefined optical path difference and described below in conjunction with the first and second focal plane arrays.

The first focal plane array 18 is positioned relative to the optical system 12 so as to receive an image of the object 14. In this regard, the optical system is designed to focus the image on a surface generally perpendicular to the optical axis 22. Although the optical axis is shown to be linear in FIG. 1, the optical axis need not be linear, but is instead defined by the optical system to define the direction along which the image of the object is focused. As such, the first focal plane array is positioned along the optical axis to receive the image of the object. Typically, the first focal plane array receives a focused image. However, the first focal plane array may receive a defocused image in some embodiments.

The second focal plane array 20 is also positioned along the optical axis 22 and is proximate to the first focal plane array 18. In contrast to the typical placement of the first focal plane array at the focal point of the optical system 12, the second focal plane array is optically displaced from the first focal plane array and, therefore, from the focal point of the optical system by a predetermined optical path distance along the optical axis. As such, the second focal plane array receives a defocused image of the object. Even in instances in which the first focal plane array is not positioned at the focal point of the optical system, the second focal plane array is optically displaced from the first focal plane array by a predetermined optical path difference, thereby establishing a difference in focus therebetween that is predefined.

In the advantageous embodiment in which the optical system scans the object, such as a line-scanned optical system that obtains a plurality of sequential linear images of the object as the object is scanned in an in-track direction, the first and second focal plane arrays are also offset in the in-track direction such that images are sequentially directed to the first and second focal plane arrays without requiring a beamsplitter as necessitated by conventional techniques.

Each focal plane array includes a support 24 and a plurality of pixels 26 disposed upon the support. Typically the pixels are arranged in an array having a rectangular or other desired shape. In embodiments in which the optical system 12 is a line-scanned optical system, for example, each focal plane array similarly includes a linear array of pixels. For example, the focal plane array assembly depicted in FIG. 2 includes first and second focal plane arrays 18, 20, each having a respective linear array of pixels. According to the present invention, the linear array of pixels of the first and second focal plane arrays are positioned proximate to one another and, more particularly, are positioned alongside one another such that the linear arrays of pixels extend in parallel and in an aligned fashion.

The focal plane array assembly 16 of the present invention may include various types of focal plane arrays as known to those skilled in the art. For example, each focal plane array may include a plurality of photosensitive devices mounted, such as by epoxy, upon a back plane surface or the like. Thus, the back plane would serve as the support upon which the photosensitive devices, each defining a respective pixel, are mounted. Typical photosensitive devices include, but are not limited to, charge-coupled devices (CCDs), CMOS image sensors, photomultipliers, avalanche photodiodes, bolometers and photographic film. The back plane may be formed of a circuit board with the photosensitive devices mounted upon a major surface of the circuit board. In another configuration, the focal plane array set may be constructed by mounting photosensitive devices on the edge of multiple circuit boards with the resulting set of boards assembled stackwise. As known to those skilled in the art, the circuit board(s) of either embodiment would also include the plurality of electrical traces connected to respective photosensitive devices in order to appropriately address the photosensitive devices and to permit the photosensitive devices to provide an output upon receipt of an image by the focal plane array.

The second focal plane array 20 is displaced from the first focal plane array 18 by a predetermined distance along the optical axis 22 as mentioned above. This displacement may be provided in various manners. In one embodiment, the first and second focal plane arrays 18, 20 each include a separate support 24, such as a separate circuit board, with the photosensitive devices typically mounted along the edges of circuit boards. Although the first and second focal planes are disposed proximate one another, the supports, such as the circuit boards, of the first and second focal plane arrays may be displaced from one another along the optical axis 22 by the predetermined optical path distance, such as by staggering or otherwise offsetting the edges of the circuit boards. As such, in this embodiment, the pixels of the first and second focal plane arrays may be identical, i.e., may have an identical size, with the displacement of the second focal plane array from the first focal plane array being provided by the displacement of the respective supports.

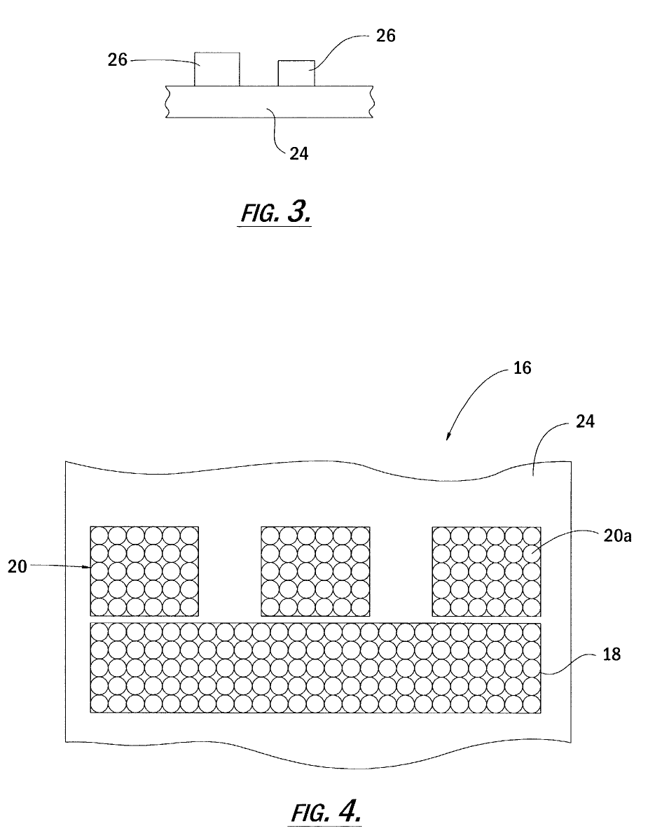

In order to provide this displacement between the first and second focal plane arrays 18, 20 according to another embodiment, the pixels of the second focal plane array preferably differ in height from the pixels of the first focal plane array by the predetermined distance. In the embodiment depicted in FIG. 2 in which the pixels 26 of the first and second focal plane arrays are mounted upon a common support 24, such as a common back plane surface, the pixels of the first and second focal plane arrays may differ in size to provide the height differential. For example, FIG. 3 depicts a representative pixel of the second focal plane array and a representative pixel of the first focal plane array.

In yet another embodiment, the difference in optical path length to the first and second focal plane arrays is effected by inserting an intervening optical element proximate to and in front of at least one of the focal plane arrays. An example of such an optical element is a glass prism with an index of refraction different than the medium, such as air, through which the optical signals are otherwise propagating. By changing the index of refraction along the optical path an effective change in focus is achieved. The medium is chosen to have minimal impact on system design and minimal effect on the image other than a change of focus.

Regardless of the construction of the focal plane array assembly 16 to provide the displacement between the first and second focal plane arrays 18, 20, the focal plane array assembly of the present invention may provide any desired displacement between the first and second focal plane arrays. In one embodiment, the second focal plane array is displaced from the first focal plane array by a predetermined distance corresponding to one half of one wavelength to one wavelenth of image defocus. However, the second focal plane array may be displaced from the first focal plane array by other predetermined distances if so desired. See, for example, J. J. Dolne, R. J. Tansey, K. A. Black, J. H. Deville, P. R. Cunningham, K. C. Widen, J. L. Hill, and P. S. Idell, “Practical Concerns for Phase Diversity Implementation Wavefront Sensing and Image Recovery”, Proc. SPIE Vol. 4493, pp. 100-111 (February 2002), which describes the defocused distance in more detail.

While the effects of optical aberrations upon the differently focused images can vary widely in the cross-track direction, it is assumed that in-track differences in the aberrations of the imaging system 10 between matched regions of the first and second focal plane arrays 18, 20 are minimal or well characterized in order to permit the images to be reliably analyzed. As such, the first and second focal plane arrays 18, 20 must be spaced sufficiently close to one another along the in-track direction such that the difference in the aberrations affecting the images are either substantially identical or can be well characterized. The separation distance between the first and second focal plane arrays which produces the desired difference in defocus will be dependent upon the optical design guidelines and may be calculated based upon standard techniques as will be understood to those skilled in the art, such as with the use of commercially available optical design software packages including, for example, the Code V™ software package available from Optical Research Associates of Pasedena, Calif.

In operation, the optical system 12 captures images of an object 14 and focuses the images upon the first and second focal plane arrays 18, 20, either concurrently or sequentially in embodiments in which the optical system scans in an in-track direction. As a result of their relative positions along the optical axis 22, the first and second focal plane arrays receive differently focused images of the object and, in one embodiment, receives focused and defocused images, respectively. By analyzing the images in accordance with phase diversity analysis techniques known to those skilled in the art and described in more detail by the Gonsalves articles, the optical aberrations introduced by the imaging system 10 may be detected. In this regard, the images may be analyzed by conventional phase diversity techniques to determine various aspects of the blur of the image, such as the coma, spherical defocus, astigmatism or the like, as known to those skilled in the art. Based upon this analysis and the detection of the optical aberrations, the optical system may be altered to correct and/or compensate for the optical aberrations in a manner also known to those skilled in the art. In conjunction with or as an alternative to correcting the optical system, the characterization of the aberrations produced by phase diversity detection may be applied to post-processing based image correction methods also known to those skilled in the art. See, for example, D. R. Gerwe et al., “Supersampling Multiframe Blind Deconvolution Resolution Enhancement of Adaptive Optics Compensated Imagery of LEO Satellites”, Proc. SPIE 4091, pp. 187-205 (2000) and D. R. Gerwe et al., “Superresolved Image Reconstruction of Images Taken Through the Turbulent Atmosphere”, J. Opt. Soc. Am. A, 15(10), pp. 2620-28 (1998) which provide further details regarding deconvolution and blind deconvolution techniques.

Although various phase diversity techniques are well known to those skilled in the art, several phase diversity techniques will be described hereinbelow for purposes of example, but not of limitation. According to one phase diversity technique, the images received by the first and second focal plane arrays 18, 20, respectively, are divided into isoplanatic blocks. Isoplanatic blocks are regions of the images for which the point spread function of the image does not vary significantly such that the blur of the image is also constant across the region. Conventional phase diversity techniques may then be applied to each pair of blocks. In this regard, each pair of blocks includes one block of the image received by the first focal plane array and one block of the image received by the second focal plane array, with the pair of blocks being aligned or otherwise corresponding positionally to one another. With respect to FIG. 2, for example, a block of the second focal plane array would have the same size and lie immediately above a corresponding block of the first focal plane array. The results of the phase diversity analysis for each pair of blocks, such as the various parameters of the blur of the image across the pair of blocks, may be interpolated across the entire image using the results of processing data collected in pairs of focal plane array blocks located at different cross-track locations of the focal plane, with the results utilized to detect optical aberrations as known to those skilled in the art. The optical system may then be modified to correct and/or compensate for the optical aberrations as also known to those skilled in the art. Alternatively the resultant wavefront characterization can be used as an input to post-processing image reconstruction techniques known to those skilled in the art.

While the second focal plane array 20 may be the same size as the first focal plane array 18, the focal plane array assembly 16 of one embodiment includes a second focal plane array having a plurality of segments 20a. Each segment includes a plurality of pixels and is positioned proximate a respective portion of the first focal plane array. In this regard, FIG. 4 depicts one focal plane array assembly in which the second focal plane array includes a plurality of segments positioned proximate different respective portions of the first focal plane array. Since the second focal plane array is formed of a plurality of segments spaced apart from one another, the second focal plane array of this embodiment receives only portions of the defocused image. In one approach the image obtained from each segment of the second focal plane array is paired with a corresponding subsection of the image obtained from the first focal plane array, and phase diversity analysis is applied to characterize the optical aberrations local to each focal plane array region. Characterization of the aberrations in regions without associated second FPA segments can be determined by interpolation and, in this fashion, the aberrations can be characterized for the full imaging field. Alternatively a point-spread function corresponding to each region may be calculated and the results interpolated to characterize the continuum of changes in its structure as a location of position with the optical field. The number and spacing between the segments of the second focal plane array are generally chosen such that changes in the aberrations across the optical field are adequately sampled.

As an alternative to interpolation, a generalized phase diversity might be used which determines values of model parameters which produce a wavefront characterization which agrees with data collected from all segments of the primary and secondary focal plane arrays. Such a model would relate the degrees of freedom in the system to the structure of the wavefront and its variations across the field-of-view and to their influence on the first and secondary focal plane arrays. As an example, B. J. Thelen et al., “Fine-Resolution Imagery of Extended Objects Observed through Volume Turbulence using Phase-Diverse Speckle”, Proc. SPIE 3763, pp. 102-111 (1999), describes a method for treating anisoplanatic variations of the wavefront aberrations which result from the volume of atmospheric turbulence between the imaging system and the object using a sequence of phase screens. According to this technique, the anisoplanatic variations of the point spread function are determined. Based upon these anisoplanatic variations of the point spread function, the optical system 12 may be adjusted to correct and/or compensate for the anisoplanatic blurring effects by either physical adjustments to the system or by image restoration methods known to those skilled in the art.

The second focal plane array 20 of this embodiment may include segments 20a of any size and may space those segments from one another by any desired distance. While the size and spacing of the segments may vary as described below, each segment is generally, but not necessarily, the same size as all other segments and the space between each pair of adjacent segments is typically, but again not necessarily, the same as all other spaces. Typically, the size of the segments and the spacing therebetween are determined based upon the application and, in particular, based upon the detail or accuracy with which the imaging system and method are designed to detect optical aberrations and the anticipated variations across the image of the object. In this regard, imaging systems and methods that desirably detect optical aberrations with high levels of accuracy generally require the segments of the second focal plane array to be larger and require more segments and/or smaller spacing between the segments. Similarly, a second focal plane array that is designed such that the structure of the wavefront aberrations is anticipated to vary significantly across the image generally requires more segments and/or smaller spacing between the segments. Depending on the design, the first focal plane array could include, for example, anywhere from thirty-two to many thousand pixels, while the second focal plane array may span the continuum from having only a few segments with each having only a few pixels to being of the same size as the first focal plane array.

According to the present invention, an improved imaging system and method are therefore provided to detect optical aberrations introduced by the imaging system 10 such that appropriate corrections and/or compensation may be provided to reduce, if not eliminate, the aberrations, thereby improving the quality of the resulting images captured by the imaging system. By capturing differently focused images with first and second focal plane arrays 18, 20 that are positioned proximate one another and displaced by the predetermined optical path distance along the optical axis 22, the images required for phase diversity analysis purposes can be captured without significantly increasing the cost, complexity and/or weight of the imaging system. Moreover, the imaging system and method can capture and analyze the in-focus and defocused images without requiring a reference beam and/or a reference point source as required by at least some conventional imaging systems that provide the capability of detecting aberrations. Similarly, the imaging system and method do not include a beam splitter or other optical elements for splitting the image between the focal plane arrays and, as such, do not reduce the signal strength of the image as required by at least some conventional phase diversity imaging systems.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A focal plane array assembly of an optical system adapted to focus an image of an object on a surface generally perpendicular to an optical axis, the focal plane array assembly comprising:
a first focal plane array comprised of a plurality of pixels, said first focal plane array positioned to receive an image of the object; and
a second focal plane array comprised of a plurality of pixels, said second focal plane array optically displaced from said first focal plane array by a predetermined optical path distance along the optical axis to thereby receive a defocused image of the object, wherein said second focal plane array is displaced from said first focal plane array such that a difference in focus between the images received by said first and second focal plane arrays is predetermined.

2. A focal plane array assembly according to claim 1 wherein said first and second focal plane arrays each further comprise a respective support on which said pixels are disposed, and wherein said supports of said first and second focal plane arrays are mounted such that said first and second focal plane arrays are offset by the predetermined optical path difference.

3. A focal plane array assembly according to claim 1 wherein the pixels of said second focal plane array differ in height from the pixels of said first focal plane array by the predetermined optical path distance.

4. A focal plane array assembly according to claim 1 wherein at least one of said first and second focal plane arrays further comprises an optical element disposed along the optical path of the image received by the respective pixels for introducing the predetermined optical path difference.

5. A focal plane array assembly according to claim 1 further comprising at least a third focal plane array for receiving defocused images of the object such that the focal plane assembly includes at least first, second and third focal plane arrays, said third focal plane array being optically displaced along the optical axis from the first and second focal plane arrays.

6. A focal plane array assembly according to claim 1 wherein said second focal plane array comprises a plurality of segments spaced apart from one another.

7. A focal plane array assembly according to claim 6 wherein each segment comprises a plurality of pixels.

8. A focal plane array assembly according to claim 6 wherein the segments of said second focal plane array are positioned proximate different respective portions of said first focal plane array.

9. A scanned imaging system comprising:
an optical system for capturing images of an object and for both focusing the images on a surface generally perpendicular to an optical axis and scanning in an in-track direction;
a first focal plane array comprised of a plurality of pixels; and
a second focal plane array comprised of a plurality of pixels, wherein said second focal plane array is offset from said first focal plane array in the in-track direction; and wherein said first and second focal plane arrays are configured such that an image received by said second focal plane array has a predefined optical path difference along the optical axis relative to an image received by said first focal plane array.

10. A scanned imaging assembly according to claim 9 wherein said optical system comprises a line-scanned optical system.

11. A scanned imaging assembly according to claim 9 wherein said first and second focal plane arrays each further comprise a respective support on which said pixels are disposed, and wherein said supports of said first and second focal plane arrays are mounted such that said first and second focal plane arrays are offset by the predetermined optical path difference.

12. A scanned imaging assembly according to claim 9 wherein the pixels of said second focal plane array differ in height from the pixels of said first focal plane array by the predetermined optical path distance.

13. A scanned imaging assembly according to claim 9 wherein at least one of said first and second focal plane arrays further comprises an optical element disposed along the optical path of the image received by the respective pixels for introducing the predetermined optical path difference.

14. A scanned imaging assembly according to claim 9 further comprising at least one additional focal plane array for receiving defocused arrays of the object, said at least one additional focal plane array optically displaced along the optical axis from the first and second focal plane arrays.

15. A scanned imaging assembly according to claim 9 wherein said second focal plane array comprises a plurality of segments spaced apart from one another.

16. A scanned imaging assembly according to claim 15 wherein the segments of said second focal plane array are positioned proximate different respective portions of said first focal plane array.

17. A method for obtaining differently focused images of an object comprising:
focusing an image of the object on a surface generally perpendicular to an optical axis;
scanning images of an object in an in-track direction across first and second focal plane arrays comprised of respective pluralities of pixels, wherein the first and second focal plane arrays are offset in both the in-track direction and along the optical axis;
receiving an image of the object with the first focal plane array; and
receiving a defocused image of the object with the second focal plane array, wherein the defocused image of the object received by the second focal plane array experiences a predefined optical path difference along the optical axis relative to the image of the object received by the first focal plane array, thereby establishing a predefined difference in focus between the images received by the first and second focal plane arrays.

18. A method according to claim 17 further comprising receiving additional defocused images of the object with at least one additional focal plane array.

19. A method according to claim 17 wherein receiving the defocused image comprises receiving only portions of the defocused image.
